(19) United States
(12) Patent Application Publication
(10) Pub. No.: US 2013/0091308 A1
(43) Pub. Date: Apr. 11, 2013

(54) MULTI PROTOCOL ADAPTER

(71) Applicants: Ki Chul Cha, Seoul (KR); Moon Young Jung, Seoul (KR); Kyung Hee Lee, Seoul (KR); Heung Soo Park, Gyeonggi-do (KR)

(72) Inventors: Ki Chul Cha, Seoul (KR); Moon Young Jung, Seoul (KR); Kyung Hee Lee, Seoul (KR); Heung Soo Park, Gyeonggi-do (KR)

(73) Assignees: HANWHA SOLUTION & CONSULTING CO., LTD., Seoul (KR); BIOSPACE CO., LTD., Seoul (KR)

(21) Appl. No.: 13/287,832

(22) Filed: Nov. 2, 2011

(30) Foreign Application Priority Data
Oct. 10, 2011 (KR) 10-2011-0102921

(51) Int. Cl. G06F 3/00

(52) U.S. Cl. 710/11

(57) ABSTRACT

A multi protocol adapter capable of implementing various communication modes is disclosed. The multi protocol adapter may include a plurality of communication ports to connect to a plurality of communication modules supporting different communication protocols, and a main controller to convert a signal received from one of a plurality of the communication modules and to output the converted signal to the other communication module. In this instance, each of a plurality of the communication modules is attachable and detachable, and may be connected to one of a plurality of the communication ports.

### BACKGROUND

1. Field of the Invention

Exemplary embodiments of the present invention relate to a multi protocol adapter capable of implementing various communication modes.

2. Description of the Related Art

Different forms of devices use a variety of different communication interfaces, for example, radio frequency identification (RFID), Bluetooth, universal serial bus (USB), and serial communication such as RS-232 or RS-485. Also, different forms of devices use different platforms or data formats of operating systems.

Accordingly, for integrated management of different forms of devices that use different communication interfaces and different platforms or data formats of operating systems, a management system should be equipped with a plurality of operating system platforms, a tool for data format conversion, and a plurality of communication interfaces.

To solve this problem, Korean Patent No. 10-1050282 (registered Jul. 12, 2011) discloses a data conversion technique that provides a communication interface with a plurality of different devices using various communication standards.

However, as wired/wireless communication modes available for agents or managers are diversified, a unit cost of a product may increase when many communication modes are embedded in a single agent or manager.

In the present specification, an adapter that may select and use a communication mode desired by a plurality of users is provided.

### SUMMARY

An aspect of the present invention provides a multi protocol adapter that may implement various communication modes and may select and use a desired communication mode.

Another aspect of the present invention also provides a multi protocol adapter that may provide a house capable of implementing various communication modes, and when a dongle supporting a desired communication mode is inserted into the house, may activate a corresponding communication.

Another aspect of the present invention also provides a multi protocol adapter that may prevent an increase in the unit cost of production unnecessarily occurring when supporting various wired/wireless communication modes.

According to an aspect of the present invention, there is provided a multi protocol adapter including a plurality of communication ports to connect to a plurality of communication modules supporting different communication protocols, and a main controller to convert a signal received from one of a plurality of the communication modules and to output the converted signal to the other communication module. In this instance, each of a plurality of the communication modules is attachable and detachable, and may be connected to one of a plurality of the communication ports.

In an aspect of the present invention, when a first dongle comprising a first communication module of a plurality of the communication modules is connected to a first communication port of a plurality of the communication ports, the main controller may recognize the first communication port connected to the first dongle, may wait for data input and output, and when the main controller receives data from a first terminal through the first communication port, may process the data based on a protocol supported by the first dongle.

In another aspect of the present invention, while the main controller is communicating with a second terminal keeping a connection to a second dongle comprising a second communication module of a plurality of the communication modules, when a communication protocol supported by the second dongle is recognizable by the main controller, the main controller may follow the communication protocol supported by the second dongle, and when a protocol supported by the second dongle is unrecognizable by the controller, the main controller may bypass.

In an aspect of the present invention, when the main controller transmits the received data to the second terminal through the second dongle comprising the second communication module of a plurality of the communication modules, the main controller may process a data transmission according to a cycle including a state check frame for checking the communication state with the second terminal, a command frame for processing a command code for the data to be transmitted, and a completion check frame for checking the transmission completion of the data.

In an aspect of the present invention, when the main controller transmits the received data to the second terminal through the second dongle comprising the second communication module of a plurality of the communication modules, the main controller may check the power state of the second terminal, and when the second terminal is powered off, the main controller may temporarily store the data and transmit the data to the second terminal at the time of powering on the second terminal.

In an aspect of the present invention, when a radio frequency identification (RFID) card is recognized through a RFID card reader connected to the second communication port of a plurality of the communication ports, the main controller may combine information related to the RFID card with the received data, and may transmit the combined data to the second terminal through the second dongle comprising the second communication module of a plurality of the communication modules.

### EFFECT OF THE INVENTION

Exemplary embodiments of the present invention may provide a house capable of implementing various communication modes, and when a dongle supporting a desired communication mode is inserted into the house, a corresponding communication may be activated. In this instance, a communication module of a specific mode may be selectively used depending on a communication mode supported by a corresponding device. Further, a communication module of a specific mode may be selectively used depending on the characteristics of a communication environment such as distance, obstacles, or interference. Accordingly, exemplary embodiments of the present invention may prevent an increase in a unit cost of production unnecessarily occurring when supporting various wired/wireless communication modes.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating the relationship between a multi protocol adapter and terminals according to an embodiment of the present invention;

FIGS. 2 and 3 are diagrams illustrating the external appearance of a multi protocol adapter according to an embodiment of the present invention;

FIG. 4 is a block diagram illustrating the internal configuration of a multi protocol adapter according to an embodiment of the present invention; and

FIG. 5 is a diagram illustrating an application example of a multi protocol adapter according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

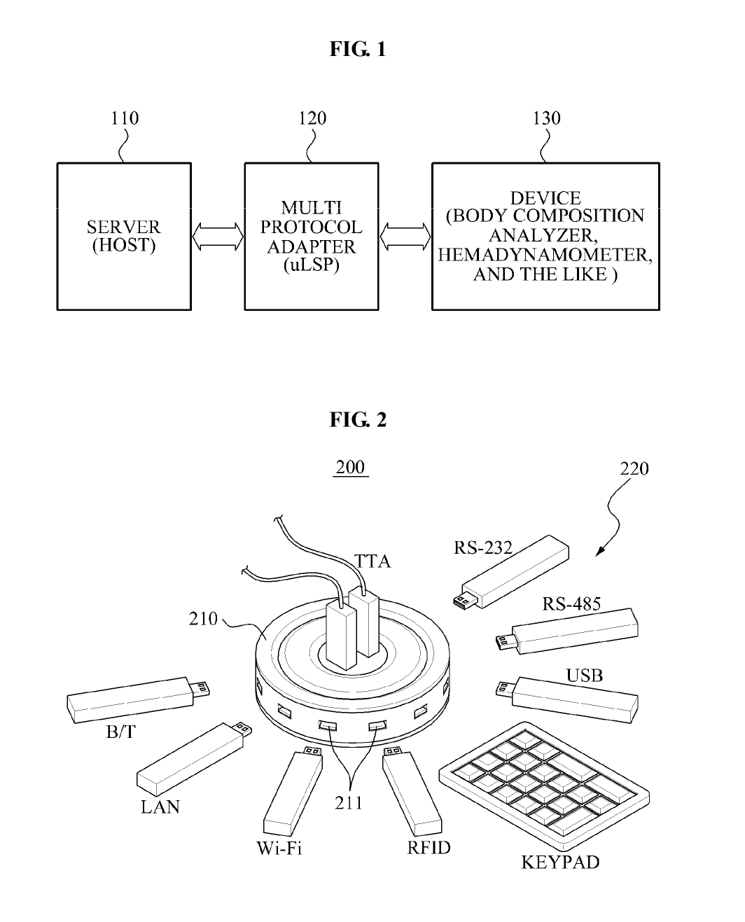

FIG. 1 is a diagram illustrating the relationship between a multi protocol adapter 120 and terminals according to an embodiment of the present invention.

The multi protocol adapter (hereinafter referred to as “uLSP”) 120 may support various communication standards (radio frequency identification (RFID), Bluetooth, universal serial bus (USB), serial communication, and the like) and a data transmission standard, and may transmit data in one communication mode.

In other words, the uLSP 120 may receive a non-standard input data of various data formats from an external device 130 via RFID, Bluetooth, USB, serial communication such as RS-232 or RS-485, and the like, and may process and transmit the input data to a host 110. Accordingly, the uLSP 120 may receive data in N communication modes and may output data in one communication mode. The communication mode used in data output may be a connected communication among Wi-Fi, Ethernet, and USB.

The uLSP 120 described in the foregoing may be used for various purposes under a ubiquitous environment. In particular, the uLSP 120 may support a medical standard, thereby making a promising contribution to expansion of u-health or u-log device industry. The uLSP 120 may permit the external device 130 of various protocols, in which a processor and an interface protocol are defined for each operating system (OS) platform.

Here, the host 110 may include terminals capable of providing a user with data measured/transmitted by the external device 130, for example, a smart phone, a personal computer, a laptop computer, and a set-top type smart cross media open platform (SXMP), as well as, a server system. Also, the external device 130 may include terminals capable of measuring and providing data, for example, a hemadynamometer, a blood sugar meter, a thermometer, and the like. The external device 130 may be manufactured to be connected to the uLSP 120, or a function of the external device 130 may be optionally selected and mounted in the uLSP 120.

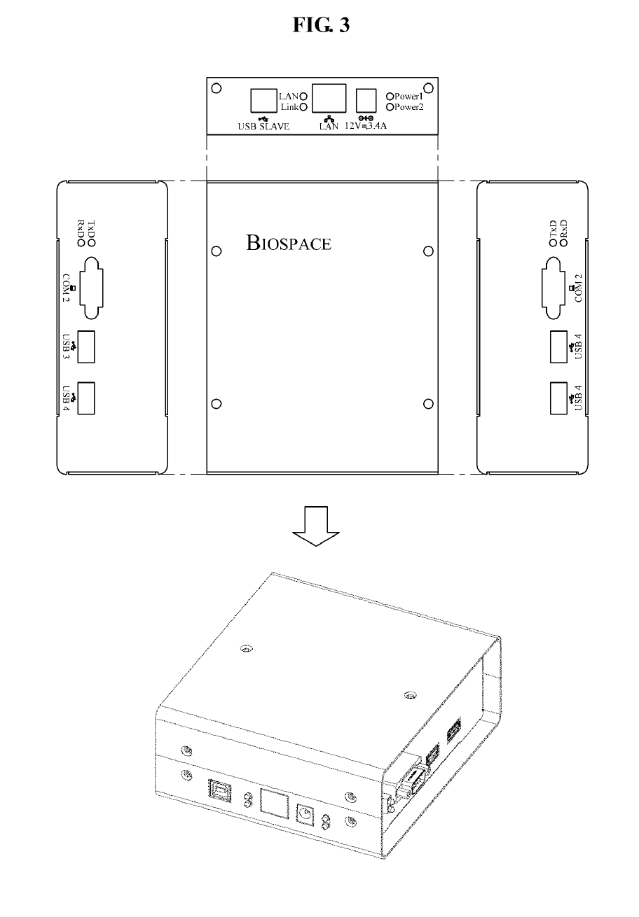

FIGS. 2 and 3 are diagrams illustrating the external appearance of a multi protocol adapter according to an embodiment of the present invention.

As shown in FIG. 2, a uLSP 200 may include a plurality of communication ports 211 on a house to implement various communication modes. In this instance, a plurality of communication ports 211 may be configured to connect to a plurality of communication modules 220 supporting different communication protocols. In the present exemplary embodiment, a plurality of communication modules 220 connectable to a plurality of communication ports 211 of the uLSP 200 may have an attaching/detaching structure, and may be connected to one of the plurality of communication ports 211.

In other words, when a dongle comprising the communication module 220 supporting a communication mode desired by a user is inserted into the corresponding port of the plurality of communication ports 211, the uLSP 200 may activate a corresponding communication.

A house 210 of the uLSP 200 may be formed in, for example, a cylindrical shape, as shown in FIG. 2, and may have a plurality of communication ports 211 along the external surface of the house 210. Alternatively, the house of the uLSP may be formed in the shape of a six-sided box, as shown in FIG. 3, and may have a plurality of communication ports along the side surfaces of the house.

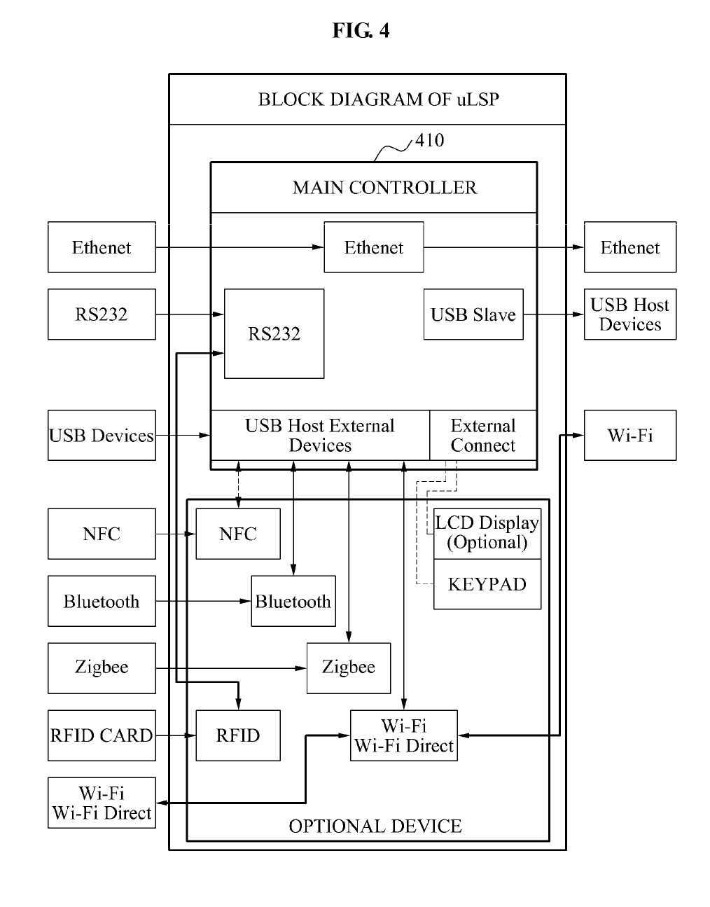

FIG. 4 is a block diagram illustrating the internal configuration of a multi protocol adapter according to an embodiment of the present invention. The uLSP according to an embodiment of the present invention may include a main controller 410 that may convert a signal received from one of a plurality of communication modules and may output the signal to the other communication module.

In this instance, a communication mode of the uLSP may include basic communication and optional communication, as shown in FIG. 4. For example, the uLSP may have, as a basic specification, USB host, USB slave, Ethernet, RS232, Wi-Fi, and Wi-Fi direct, and may have, as an option, select and use Bluetooth, ZigBee, RFID, and near field communication (NFC). Here, as shown in FIGS. 2 and 3, the uLSP may have an integral external appearance regardless of, whether the communication mode is a basic communication or an optional communication.

Also, the uLSP may support the medical standard IEEE 11073 HDP (continuous) protocol, and may have a link function with a terminal such as a hemadynamometer, a blood sugar meter, a body composition analyzer (for example, InBody), and the like. Also, the uLSP may basically have a keypad for interfacing with a user, and may optionally have a display means, for example, a liquid crystal display (LCD).

The uLSP may receive data through ports of various modes via communication of Ethernet, RS232, USB, NFC, Bluetooth, ZigBee, RFID, or Wi-Fi, and may output the input data via a connected communication among Ethernet, USB, and Wi-Fi. That is, a specific device port is not set by the uLSP for one to N bypass communication. Instead the uLSP may enable a device to operate when the device is inserted into any port.

The basic communication mode of the uLSP may be such that the uLSP bypasses data to establish a communication between an external device and a host.

Specifically, when a first dongle comprising a first communication module of a plurality of communication modules is connected to a first communication port of a plurality of communication ports, the main controller 410 may recognize the first communication port connected to the first dongle, may wait for data input/output, and when the main controller 410 receives data through the first communication port, may process the data based on a protocol supported by the first dongle.

When data is received from a host, the main controller 410 may basically process data transmission through state checking, commanding, and completion checking. In other words, when the main controller 410 intends to transmit data received through the first communication module to an external device through a second dongle comprising a second communication module of a plurality of communication modules, the main controller 410 may process data transmission according to a cycle including a state check frame for checking the communication state with the external device, a command frame for processing a command code for data to be transmitted, and a completion check frame for checking the completion of data transmission to the external device. After the state checking, the main controller 410 may report a state change of the external device, and when the data is stored in the external device, the main controller 410 may preferentially respond to a data request from the uLSP, and when the data is absent in the external device, may transmit data through the uLSP. That is, when the uLSP receives a signal from a host through one of a plurality of ports capable of input/output, the uLSP may set the corresponding port as a communication port and may transmit data through the port.

Also, when data is received from a host, the main controller 410 may configure a command protocol in which transmission of six frames including state checking, state response, command code, command code response, completion, and completion response is set as one cycle. Alternatively, completion and completion response may be omitted from the six frames, and four frame transmission may be set as one cycle.

Also, while the main controller 410 is communicating with an external device keeping a connection to the second dongle comprising the second communication module of a plurality of communication modules, when the main controller 410 can recognize a communication protocol supported by the second dongle, the main controller 410 may follow the communication protocol supported by the second dongle. On the contrary, when the main controller 410 a communication protocol supported by the second dongle is unrecognizable, the main controller 410 may bypass. In other words, when the external device is a device of which a protocol can be recognized by the uLSP, a communication between the external device and the uLSP may follow the protocol of the device, and when the external device is a device of which a protocol is unrecognized by the uLSP, a communication between the external device and the uLSP may be bypassed.

Also, when the main controller 410 transmits data received from the external device to the host, the main controller 410 may check the power state of the host. When the host is powered off, the main controller 410 may temporarily store the data, and may transmit the data at a time of powering on the host. Accordingly, the uLSP may have a function of storing a predetermined amount of data when the uLSP identifies data transmission as being impossible, for example, when a connection to a set-top box is not established.

Also, when a RFID card is recognized through a RFID card reader connected to one of a plurality of communication ports, the main controller 410 may combine information related to the RFID card with data received from the external device, and may transmit the combined data to the host in a communication mode. In this instance, the main controller 410 may identify personal information via RFID communication, and when data is transmitted from the external device by the contact between the RFID card and the RFID card reader, the main controller 410 may first transmit the information related to the RFID card and then may bypass the corresponding data. Also, when the RFID card is contacted with the RFID card reader connected to the uLSP, the uLSP may call for a specific app of a server and may transmit data measured by the external device to the server, so that the measured result may be immediately displayed on a page of the corresponding app.

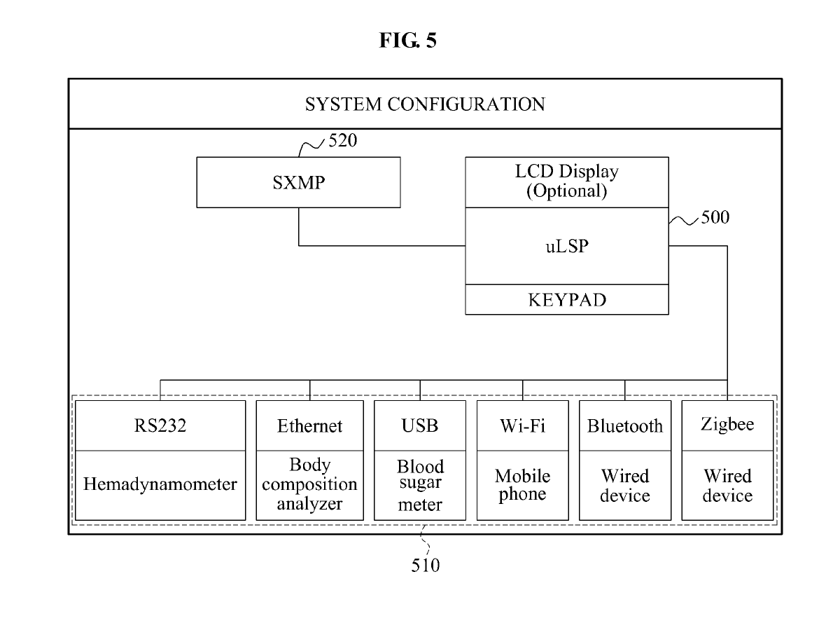

FIG. 5 is a diagram illustrating an application example of a multi protocol adapter according to an embodiment of the present invention. In FIG. 5, a uLSP 500 may be connected to a variety of terminals in various communication modes of protocols supported by the uLSP 500.

The uLSP 500 may be connected to external devices 510 through ports of various modes. For example, the uLSP 500 may be connected to a hemadynamometer through an RS232 port, a body composition analyzer through an Ethernet port, a blood sugar meter through a USB port, a mobile phone through a Wi-Fi port, and each wired device through a Bluetooth port and a ZigBee port. In this instance, when data is stored in the external device 510, the uLSP 500 may transmit the corresponding data to an SXMP 520 in a connected communication mode among Wi-Fi, Ethernet, and USB. That is, a manager may receive blood pressure, body composition, blood sugar, and personal information from many users through the SXMP 520, and may integratedly manage the information.

Hereinafter, a communication protocol of uLSP is described in detail.

First, a setting function of uLSP may be set via USB communication in a personal computer or an SXMP that is connected to the uLSP. The uLSP may be set by an ASCII command through a USB slave communication port.

The uLSP may be linked to a server via Ethernet, Wi-Fi, or USB slave communication. The server may operate as a host, and the uLSP may operate as a slave, and when data is transmitted from the host through one of the three ports, the uLSP may echo the data and may set the corresponding port as a communication port. In this instance, according to the basic concept of one to N communication, when a protocol is transmitted from the server to the uLSP, the uLSP may transmit data of the server to a corresponding device based on the number of an ID item of the protocol, and in turn, may set an ID of the corresponding device to the data received from the device and may transmit the data to the server. When there is a change in the device connected to the USB port according to connection/disconnection, the uLSP may report the current connection state to the server, and the server may then register a device of a new ID.

Communication Data Rule

(1) A communication between a set-top box (host) and uLSP is made such the uLSP responds to a command of the set-top box.

(2) Data to be transmitted from the uLSP to the set-top box:

The uLSP transmits data with a unique command data/time in response to a request by the set-top box, and after the uLSP receives a transmission completion command, the uLSP copes with the communication lose by deleting the data.

(3) Data to be transmitted from the set-top box to the uLSP:

A command of the set-top box basically has a structure of state checking and commanding, or a structure of state checking, commanding, and checking.

After the state checking, the set-top box reports a state change of an external device, and when the data is stored in the external device, preferentially responds to a data request from the uLSP, and when the data is not stored in the external device, transmits the data through the uLSP.

(4) When a communication is disconnected and data transmission is not made for a predetermined time, the set-top box makes a response request to the uLSP again, and when there is no response several times or more, the set-top box considers that communication is disconnected.

Communication Protocol Basics

(1) ID

An ID is used to identify the kind of an external device used between a set-top box and uLSP. For example, ‘A’ may be a COM1 port, ‘B’ may be a COM2 port, ‘1’ to ‘4’ may be data corresponding to the number of a device connected to a USB port, and ‘X’ may be used as a communication ID for data transmission between the set-top box and the uLSP.

(2) CMD

When ASCII data is received from an external device, the stored data is transmitted while being carried on the first string of the protocol and a unique data date/time carried on the second string, by [aa]CMD.

(3) String

When ASCII data is received from an external device, the stored data is while being carried on the first string of the protocol. The ASCII data is transmitted, indicating one bite as two hexadecimal bytes. For example, 0x30,0x5B ASCII data is transmitted on the first string as “305B”.

The uLSP transmits a unique command date/time on the last string of the protocol. The unique command date/time is transmitted, indicating 15 byes of “yyyymmddhhmmssx” (x is ‘0’ as a reference, and when the time is the same, a next unique command date/time is registered after increasing to ‘1’. Accordingly, unique command date/time of the same time can be registered up to ten).

According to an example of data transmission, when protocol data of a hemadynamometer is transmitted to uLSP through COM1, the set-top box receives the data as a protocol including ID ‘A’, CMD, data transmitted from the COM1, and a unique command date/time carried on the last string. When the set-top box intends to transmit 0x58,0x5c ASCII data of two bytes to USB1, the set-top box transmits ID ‘1’, [aa]CMD, and “585c” carried on the first string to the uLSP.

Communication Protocol

In a protocol between a set-top box and uLSP, an ID between two devices is transmitted as ‘X’, and an ID for data transmission is transmitted as an ID of a corresponding device.

| | | |
|---|---|---|
| Set-top box | [@Y] -----------------> | uLSP |
| Set-top box <--------------------- | [@Y] | uLSP |
| Set-top box | [##] -------------------> | uLSP |
| Set-top box <--------------------- | [##] | uLSP |
| Set-top box | [@Z] -----------------> | uLSP |
| Set-top box <--------------------- | [@Z] | uLSP |

When the set-top box receives data, data transmission follows a command protocol in which transmission of six frames including state checking, state check response, command code, command code response, completion, and completion response is set as one cycle. Alternatively, completion and completion response may be omitted and four frame transmission may be set as one cycle.

(1) Data Transmission Mode

A data transmission mode is a basic mode of uLSP. In this mode, data transmitted from an external device to uLSP is transmitted to a set-top box, and data transmitted to the set-top box is transmitted to a corresponding external device.

(1-1) State Checking

<Basic Communication Structure>

| | | |
|---|---|---|
| Set-top box | [@Y] -----------------> | uLSP |
| Set-top box <----------------- | [@Y] | uLSP |

| | |
|---|---|
| [#] | //the current mode of uLSP |
| [###] | //the number of stored data |
| [####] | //usb device change flag |

<Description>

IDs used in sending and receiving data are both ‘X’.

First string: ‘u’: uLSP mode ‘s’: setup mode

Second string: “000”˜“999”

Third string: when ‘C’ flag is set, a device setting operation is performed.

For example, “dddd”—no USB port is connected.

“cddd”—a device is connected to USB PORT 1

“cdcd”—each device is connected to USB PORT 1 and USB PORT 3.

<Note>

The maximum number of uLSP data to be stored is 999. In the case of data communication via Ethernet, when [@Y] command is transmitted to a USB slave device or a WLAN port, the uLSP makes a response to the port that has received the command. When data is transmitted to the uLSP via Ethernet or WLAN, it is possible to identify an IP by using an IP of the USB slave device at the initial booting or a protocol command defined in a setup setting mode.

(1-2) Transmission Checking

<Basic Communication Structure>

```
    Set-top box [@Z] -----------------> uLSP
        [yyyymmddhhmmssx] //unique command date/time at the time
of transmission completion
    Set-top box <------ [@Z] uLSP
        [yyyymmddhhmmssx] //unique command date/time of deleted
data
```

<Description>

When the uLSP receives a unique command date/time by [@Z]command, the uLSP deletes the corresponding data and transmits the [@Z] command to the set-top box.

<Note>

When deletion is needed, [@Z] command is transmitted, and if not so, may not be transmitted.

(1-3) Data Receiving

<Basic Communication Structure>

| | |
|---|---|
| Set-top box [@R] -----------------> | uLSP |
| Set-top box <-------- [$$] | uLSP |

```
      [&&&&&&] //data defined in a protocol
      [yyyymmddhhmmssx] // add unique command date/time to the
      last string
```

| | |
|---|---|
| Set-top box <-------- [@R] | uLSP// when there is no data to be |
| | transmitted |

<Description>

When [@R] command is received after a state check command, the most lately received data protocol is transmitted. A frame ID used in data transmission to the set-top box is an ID corresponding to a port through which the data is received from the uLSP. This is to check which port is used in receiving the data.

<Note>

After the data is received, a transmission check command is transmitted to the uLSP to delete the received data. When the data is not deleted, the same data is transmitted to the set-top box in response to a next transmission request. When the same data is transmitted even after the transmission check command, it is regarded that a communication protocol is not normally completed.

<Example of Data Receiving by Set-Top Box>

| | | |
|---|---|---|
| Set-top box | [@Y] ---------------> | uLSP |
| Set-top box <--------------- | [@Y] | uLSP |
| Set-top box | [@R] ---------------> | uLSP |
| Set-top box <--------------- | [$$] | uLSP |
| Set-top box | [@Z] ---------------> | uLSP |
| Set-top box <--------------- | [@Z] | uLSP |

(1-4) Data Sending <Basic Communication Structure>

| Set-top box | [@Y] ---------------> | uLSP |
|---|---|---|
| | [&&&&&&] // data defined in protocol | |
| Set-top box <--------------- | [@Z] | uLSP |

<Description>

When the protocol is transmitted to the uLSP after [@Y] state check command, the protocol is transmitted to a port by which the corresponding command is defined, and [@S] command is transmitted to the set-top box.

<Example of Data sending by Se-Top Box>

| | | |
|---|---|---|
| Set-top box | [@Y] ---------------> | uLSP |
| Set-top box <--------------- | [@Y] | uLSP |
| Set-top box | [$$] -----------------> | uLSP |
| Set-top box <--------------- | [@S] | uLSP |

(2) Setup Setting Mode

A basic rule is such that a data communication function stops during setup setting. Also, the uLSP operates according to a command of the set-top box and executes the received command regardless of the commands, whether [@Y] or [@Z].

(2-1) Start/End of Setup Setting

| | |
|---|---|
| Set-top box | [@T] ---------------> uLSP |
| | [#] - setup setting flag |
| Set-top box <--------------- | [@T] uLSP |
| | [#] - setup setting flag |

<Data Structure>

First string 1: start, 0: end

<Description>

The mode is changed to a setup setting/check mode, and in this time, data of the external device is not stored in the set-top box. Only in the corresponding mode, a command response for data related to setup is possible.

LAN

A network value continuously changes and the state checking is possible, however when a communication with the uLSP is intended to be made via LAN or wireless LAN, a communication function normally operates only after re-start.

(2-2) Change to Static IP

<Basic Communication Structure>

Set-top box [SI]→uLSP

Set-top box ←[SI] uLSP

<Data Structure>

First string ip1 [xxx]

Second string ip2 [xxx]

Third string ip3 [xxx]

Fourth string ip4 [xxx]

Fifth string netmask1 [xxx]

Sixth string netmask2 [xxx]

Seventh string netmask3 [xxx]

Eighth string netmask4 [xxx]

Ninth string gateway1 [xxx]

Tenth string gateway2 [xxx]

Eleventh string gateway3 [xxx]

Twelfth string gateway4 [xxx]

<Description>

A static IP desired to be set is transmitted.

(2-3) Change to Dynamic Host Communication Protocol (DHCP)

<Basic Communication Structure>

Set-top box [SC]→uLSP

Set-top box ←[SC] uLSP

Set-top box [SD]→uLSP//state checking

Set-top box ←[SD] uLSP

<Data Structure>

Ethernet setting is changed to DHCP.

When the uLSP responds to [SD] command,

First string [W/F] W: Working, F: Finish

(2-4) Read the Currently Set Address

<Basic Communication Structure>

Set-top box [SR]→uLSP

Set-top box ←[SR] uLSP

<Data Structure>

First string ip 1 [xxx]

Second string ip2 [xxx]

Third string ip3 [xxx]

Fourth string ip4 [xxx]

Fifth string netmask1 [xxx]

Sixth string netmask2 [xxx]

Seventh string netmask3 [xxx]

Eighth string netmask4 [xxx]

Ninth string gateway1 [xxx]

Tenth string gateway2 [xxx]

Eleventh string gateway3 [xxx]

Twelfth string gateway4 [xxx]

<Description>

The set IP is received.

(2-5) Read WLAN AP Device Information

<Basic Communication Structure>

Set-top box [WL]→uLSP

Set-top box ←[WL] uLSP

<Data Structure>

$$\begin{matrix}\begin{matrix}\begin{matrix}First string ID [ xxxxxxx ] \\ Second string ID [ xxx ]\end{matrix} \\ …\end{matrix} \\ Last string [ SSID FINISH ]\end{matrix}$$

<Description>

An ID of an AP identifiable by the uLSP is transmitted.

(2-6) Connect to a Corresponding WLAN ID

<Basic Communication Structure>

| | | |
|---|---|---|
| Set-top box | [WC] ---> | uLSP // setting change |
| Set-top box <--- | [WC] | uLSP |
| Set-top box | [WD]---> | uLSP // state checking |
| Set-top box <--- | [WD] | uLSP |

<Data Structure>

In the [WC] command transmission of the set-top box,

First string ID to be set [xxxxxxx]

Second string Password to be set [xxxxxxx]

When the uLSP responds to [WD] command,

First string [W/F] W: Working, F: Finish

<Description>

An ID of an AP identifiable by the uLSP is transmitted. The [WC] command must be executed only after the [WL] command is executed. Since it takes several tens of seconds to make a connection, a standby command is transmitted every two seconds. The final setting is completed, or when the final setting fails, the final setting is completed after a final check command is transmitted. After F string is received by the [WD] command, another command is executed.

(2-7) Read a WLAN Address

<Basic Communication Structure>

Set-top box [WR]→uLSP

Set-top box ←[WR] uLSP

<Data Structure>

First string ip1 [xxx]

Second string ip2 [xxx]

Third string ip3 [xxx]

Fourth string ip4 [xxx]

Fifth string netmask1 [xxx]

Sixth string netmask2 [xxx]

p Seventh string netmask3 [xxx]

Eighth string netmask4 [xxx]

Ninth string gateway1 [xxx]

Tenth string gateway2 [xxx]

Eleventh string gateway3 [xxx]

Twelfth string gateway4 [xxx]

<Description>

Read an IP address of a connected WLAN.

Accordingly, the multi adapter protocol according to the exemplary embodiments may implement various communication modes through a plurality of communication modules of an attaching/detaching structure, while minimizing the unit cost of production.

As described in the foregoing, the exemplary embodiments may provide a house capable of implementing various communication modes, and when a dongle supporting a desired communication mode is inserted into the house, may activate a corresponding communication. In this instance, a communication module of a specific mode may be selectively used depending on a communication mode supported by a corresponding device, and further, a communication module of a specific mode may be selectively used depending on characteristics of the communication environment such as distance, obstacles, or interference. Accordingly, an increase in the unit cost of production unnecessarily occurring when supporting various wired/wireless communication modes may be prevented.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A multi protocol adapter comprising:
a plurality of communication ports to connect to a plurality of communication modules supporting different communication protocols; and
a main controller to convert a signal received from one of a plurality of the communication modules and to output the converted signal to the other communication module,
wherein each of a plurality of the communication modules is attachable and detachable, and is connected to one of a plurality of the communication ports.

2. The multi protocol adapter of claim 1, wherein when a first dongle comprising a first communication module of a plurality of the communication modules is connected to a first communication port of a plurality of the communication ports, the main controller recognizes the first communication port connected to the first dongle, waits for data input and output, and when the main controller receives data from a first terminal through the first communication port, processes the data based on a protocol supported by the first dongle.

3. The multi protocol adapter of claim 2, wherein while the main controller is communicating with a second terminal keeping a connection to a second dongle comprising a second communication module of a plurality of the communication modules, when a communication protocol supported by the second dongle is recognizable by the main controller, the main controller follows the communication protocol supported by the second dongle, and when a protocol supported by the second dongle is unrecognizable by the main controller, the main controller bypasses.

4. The multi protocol adapter of claim 2, wherein when the main controller transmits the received data to the second terminal through the second dongle comprising the second communication module of a plurality of the communication modules, the main controller processes data transmission according to a cycle including a state check frame for checking the communication state with the second terminal, a command frame for processing a command code for the data to be transmitted, and a completion check frame for checking the transmission completion of the data.

5. The multi protocol adapter of claim 2, wherein when the main controller transmits the received data to the second terminal through the second dongle comprising the second communication module of a plurality of the communication modules, the main controller checks the power state of the second terminal, and when the second terminal is powered off, the main controller temporarily stores the data and transmits the data to the second terminal at the time of powering on the second terminal

6. The multi protocol adapter of claim 2, wherein when a radio frequency identification (RFID) card is recognized through a RFID card reader connected to the second communication port of a plurality of the communication ports, the main controller combines information related to the RFID card with the received data, and transmits the combined data to the second terminal through the second dongle comprising the second communication module of a plurality of the communication modules.
